(19) United States
(12) Patent Application Publication
(10) Pub. No.: US 2014/0365369 A1
(43) Pub. Date: Dec. 11, 2014

(54) WEB-BASED ACCOUNT MANAGEMENT WITH ACCESS RESTRICTIONS

(71) Applicant: eDeposit Corporation, Rockville, MD (US)

(72) Inventor: Norman Understein, Potomac, MD (US)

(21) Appl. No.: 14/297,996

(22) Filed: Jun. 6, 2014

Related U.S. Application Data
(60) Provisional application No. 61/832,496, filed on Jun. 7, 2013.

(51) Int. Cl. G06Q 20/40

(52) U.S. Cl. CPC G06Q 20/405
USPC 705/44

(57) ABSTRACT

A payment account is administered with access restrictions using a payment system. Once the payment account is established, a consumer can request a payment of funds from the payment account to enter into a transaction. The transaction is identified, and account restrictions based on characteristics of the transaction are accessed. Payment is effected according to parameters of the transaction and subject to the account restrictions. The system and method have applications in casino gambling, use restrictions relating to Government subsidies, personal budgets and spending behavior, etc.

### CROSS-REFERENCES TO RELATED APPLICATIONS

This application claims the benefit of U.S. Provisional Patent Application Ser. No. 61/832,496, filed Jun. 7, 2013, the entire content of which is herein incorporated by reference.

### STATEMENT REGARDING FEDERALLY SPONSORED RESEARCH OR DEVELOPMENT

(Not Applicable)

### BACKGROUND OF THE INVENTION

The invention relates to web-based account management with access restrictions and, more particularly, to a web-based account management system that can enable regulatory authorities, users or other third parties to establish limits or restrictions with regard to access to funds or payment processing.

In certain circumstances, it may be desirable for a regulatory authority or a third party to impose spending limits on an individual. An exemplary application could be in the context of an account associated with Internet gaming. Several states are considering regulations for Internet gaming that require a funding source to be capable of implementing such limitations. In still other applications, individuals may desire to self-regulate spending in order to manage a budget, facilitate control, or the like.

### BRIEF SUMMARY OF THE INVENTION

The invention will be described in the context of an application to Casino gaming. Other exemplary applications will be described, and the invention is not meant to be limited to the described applications.

Various states are proposing funding controls with regard to Internet gaming. Example requirements include daily limits, lifetime limits, and exclusions to individuals where funding would not be permitted. The system and methodology of the invention provide for a personal funding account incorporating the restrictive provisions, either defined by the regulations or possibly user-defined restrictions. The account would serve to provide funds subject to the applicable limits. For example, a funded account could be fully used for most services, but also may include limitations with regard to gaming, adult digital media, self-imposed spending limits, etc. An individual can set self-imposed funding or credit limits (through the account provider or other credit facilities, like financial institutions and credit cards) where an individual or family can set global spending limits (daily, monthly, annual, or lifetime), and the account administrator would check those restrictions before releasing funds (if the funding is provided by the account administrator), or the system could advise (via a legal notice or the like) that funding for credit limits have been set for the individual, where other financial institutions or credit cards can consult or “ping” the account restricted provisions before issuing funding or credit. The account administrator can provide a central location where an individual can self-impose spending limits or spending limits for certain types of transactions (e.g., gaming, adult digital media, etc.), and any credit card, or financial institution or funding source would be required to electronically check the account administrator and/or its database before issuing funding or credit.

In an exemplary embodiment, a method of administering a payment account with access restrictions using a payment system includes the steps of (a) enabling a consumer to establish a payment account, the payment account to be administered by the payment system; (b) enabling the consumer to request a payment of funds from the payment account to enter into a transaction; (c) the payment system identifying the transaction and accessing account restrictions based on characteristics of the transaction; and (d) the payment system effecting the payment according to parameters of the transaction and subject to the account restrictions. Step (a) may be practiced by enabling the consumer to designate the payment account for a predefined purpose, where the predefined purpose may include predefined account restrictions. The predefined purpose may be casino gambling, where step (a) may be further practiced by obtaining consumer information according to a regulatory authority. Step (a) may be practiced by verifying the consumer's identity and/or location. The account restrictions may include a daily limit. In this context, the method may further include a step of reserving an amount of funds in the payment account corresponding to the daily limit, where a balance in the account may consist of an amount of unreserved funds in the payment account. The account restrictions may further include at least one of a weekly limit, a monthly limit, an annual limit, and a lifetime limit. In another embodiment, the account restrictions may include self-imposed spending limits input by the consumer. Step (b) may include enabling the consumer to request credit for the payment. The account restrictions may be defined by a regulatory authority based on the characteristics of the transaction.

In another exemplary embodiment, a computer system administers a payment account with access restrictions using a payment system. The computer system includes a network interface enabling at least one user computer running a computer program to establish a payment account, and a system server running a server program. The at least one user computer and the system server are interconnected by a computer network. The payment account is administered by the system server. Upon access to the system server by a consumer, the system server enables the consumer to request a payment of funds from the payment account to enter into a transaction. The system server identifies the transaction and accesses account restrictions based on characteristics of the transaction. The system server effects the payment according to parameters of the transaction and subject to the account restrictions.

In yet another exemplary embodiment, a non-transitory computer-readable medium is programmed for administering a payment account with access restrictions using a payment system.

### BRIEF DESCRIPTION OF THE DRAWINGS

These and other aspects and advantages will be described in detail with reference to the accompanying drawings, in which:

FIG. 1 is a schematic diagram of the deposit/payment system for administering a payment account;

FIG. 2 is a flow diagram illustrating the administration of a payment account with access restrictions; and

FIG. 3 is a detailed schematic illustration of a computer system.

### DETAILED DESCRIPTION OF THE INVENTION

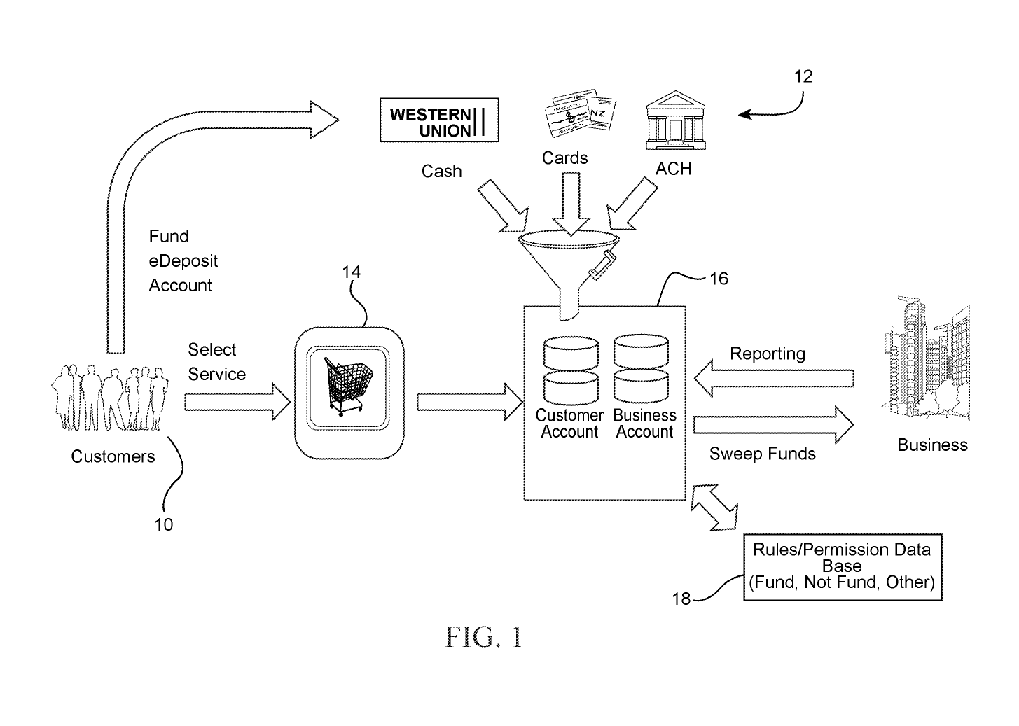

FIG. 1 is a schematic illustration showing the structural framework for administering a payment account. A customer or consumer 10 can establish a payment account by accessing an administrator website and inputting pertinent customer information. The account can be funded using various sources 12 as shown in FIG. 1. After the account is established, the consumer 10 can request a payment of funds from the account to enter into a transaction for various products or services 14.

The account is administered by a payment system 16. “Sweep Funds” is the process of taking the funds from user's account and applying them to the “Business” for use in the proposed transaction. “Reporting” is the process of the “Business” providing information to the account administrator (this could be (a) required restrictions on the user's account, or (b) an accounting of the funds of the user, so that the administrator can then reflect this information and the transaction in the user's account

In accordance with preferred embodiments, the payment system 16 identifies the requested transaction and accesses account restrictions 18 based on characteristics of the transaction. Subsequently, the payment system 16 effects the payment according to parameters of the transaction and subject to the account restrictions.

For accounts subject to regulatory restrictions, such as in the context of Internet gaming, the account would be so designated with predefined restrictions (according to rules of the jurisdiction(s) in which Internet gaming would be conducted). The regulatory authority may require specific information to be obtained from the individual, and the regulatory authority may require that certain information be verified. In the gaming context, for example, limitations may be provided on individuals that can establish an account, with restrictions on, for example, members of the judiciary, members of the legislature, city leaders, casino employees, individuals with casino conflicts, etc. Information required may include name, date of birth, social security number, address, telephone number, etc. The system may be required to verify the user's identity and geolocation according to pre-established standards. Additionally, the account administrator can establish safe vehicles, such as passwords or encryption, enabling the user to access the account.

Funding may be provided by the user or a third party (such as a casino in the context of the Internet gaming application), and funds may be withdrawn subject to restrictions, if any, with regard to daily limits, weekly limits, lifetime limits, self-imposed limits, etc.

Funding would only be made when the individual meets all of the non-restricted requirements, as determined according to the pre-established restrictions (either on the account administrator's database, a Governmental database, or another third party database).

Information provided by users will be maintained via a secure network, and in the casino gaming application, unless required by law, will not be accessible to casino operators.

In a personal context, users themselves can define spending limits specified by spending category and/or transaction type. If the particular user is approaching or has reached a spending limit based on a user-defined budget (e.g., a monthly spending limit), the system is configured to prevent access to any funds in the account. Of course, the user may be provided with the opportunity to adjust budgets and limitations for user-defined parameters.

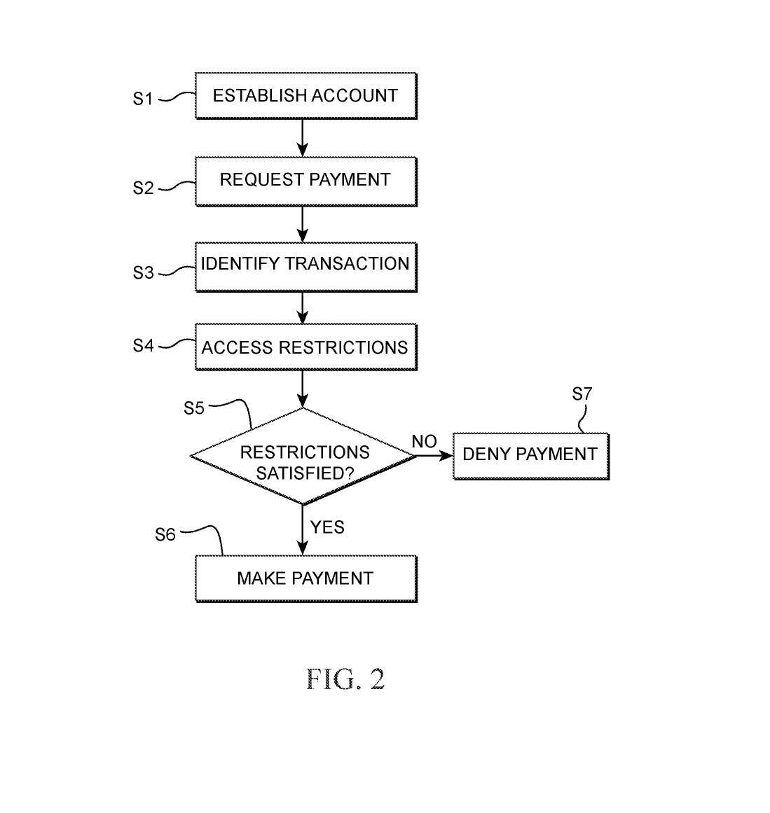

FIG. 2 is a flow chart showing the administration of a payment account with access restrictions. In step S1, a consumer establishes a payment account online (via Internet and/or mobile access or the like). The consumer can request a payment of funds from the payment account to enter into a transaction (step S2). The system identifies the transaction (step S3) and accesses account restrictions based on characteristics of the identified transaction (step S4). The system determines whether the restrictions are satisfied (step S5), and if so, the payment system effects the payment according to parameters of the transaction (step S6). If the restrictions are not satisfied, payment is denied (step S7).

In establishing the account in step S1, the consumer may designate the payment account for a predefined purpose (e.g., casino gaming), where the predefined purpose includes predefined account restrictions. Exemplary predefined account restrictions may be those required by a regulatory authority or the like. For example, if a particular state has specific requirements and/or limitations for online gambling, after the consumer designates the payment account for a gambling purpose, the account restrictions are established according to the parameters defined by the regulatory authority. Exemplary restrictions include verification of consumer location (i.e., verification that a user resides in a state where online gambling is legal) and age verification. States and/or other regulatory authorities may require funding limits as discussed above. The parameters are also adaptable to the National Counsel on Problem Gambling Standards. In step S5, when it is determined that all of the restrictions have been satisfied, the payment system effects payment, which is preferably an immediate, real-time payment of non-reversible player funds to the host casino.

In the context of a predefined daily limit, when a consumer indicates a desire to participate in casino gambling, the payment system can reserve an amount of funds in the payment account corresponding to the daily limit. These funds reside in the payment account but are otherwise unavailable to the consumer. As such, a balance in the account consists of an amount of unreserved funds in the payment account. According to the predefined restrictions, once the user has expended the daily limit, the system prevents further user access to funds for casino gambling.

The system provides immediate game access to internet casino players while reducing casino risk. The consumer uses the payment account to fund internet or in-person casino games. The casino, via API (application programming interface) or the like verifies in the player account an amount to transfer to the games. The consumer is provided an opportunity to approve the transfer (via a pin entry or the like) to the casino games. The funds are transferred to the casino in real time. Consumers can withdraw excess funds from the casino games in real time to their payment account and subsequently to their bank or credit card according to user-defined account preferences.

The web-based account management system described with reference to FIGS. 1 and 2 is preferably a browser-based system in which a program running on a user's computer (the user's web browser) requests information from a server program running on a system server. The system server sends the requested data back to the browser program, and the browser program then interprets and displays the data on the user's computer screen. The process is as follows:

1. The user runs a web browser program on his/her computer.

2. The user connects to the server computer (e.g., via the Internet). Connection to the server computer may be conditioned upon the correct entry of a password as is well known.

3. The user requests a page from the server computer. The user's browser sends a message to the server computer that includes the following:
the transfer protocol (e.g., http://); and
the address, or Uniform Resource Locator (URL).

4. The server computer receives the user's request and retrieves the requested page, which is composed, for example, in HTML (Hypertext Markup Language).

5. The server then transmits the requested page to the user's computer.

6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java™ enable the browser, among other things, to play sound and/or display video inserted in the HTML file. The fonts installed on the user's computer and the display preferences in the browser used by the user determine how the text is formatted.

If the user has requested an action that requires running a program (e.g., a search), the server loads and runs the program. This process usually creates a custom HTML page “on the fly” that contains the results of the program's action (e.g., the search results), and then sends those results back to the browser.

Browser programs suitable for use in connection with the account management system of the present invention include Mozilla Firefox® and Internet Explorer available from Microsoft® Corp.

While the above description contemplates that each user has a computer running a web browser, it will be appreciated that more than one user could use a particular computer terminal or that a “kiosk” at a central location (e.g., a cafeteria, a break area, etc.) with access to the system server could be provided.

It will be recognized by those in the art that various tools are readily available to create web pages for accessing data stored on a server and that such tools may be used to develop and implement the system described above and illustrated in the accompanying drawings.

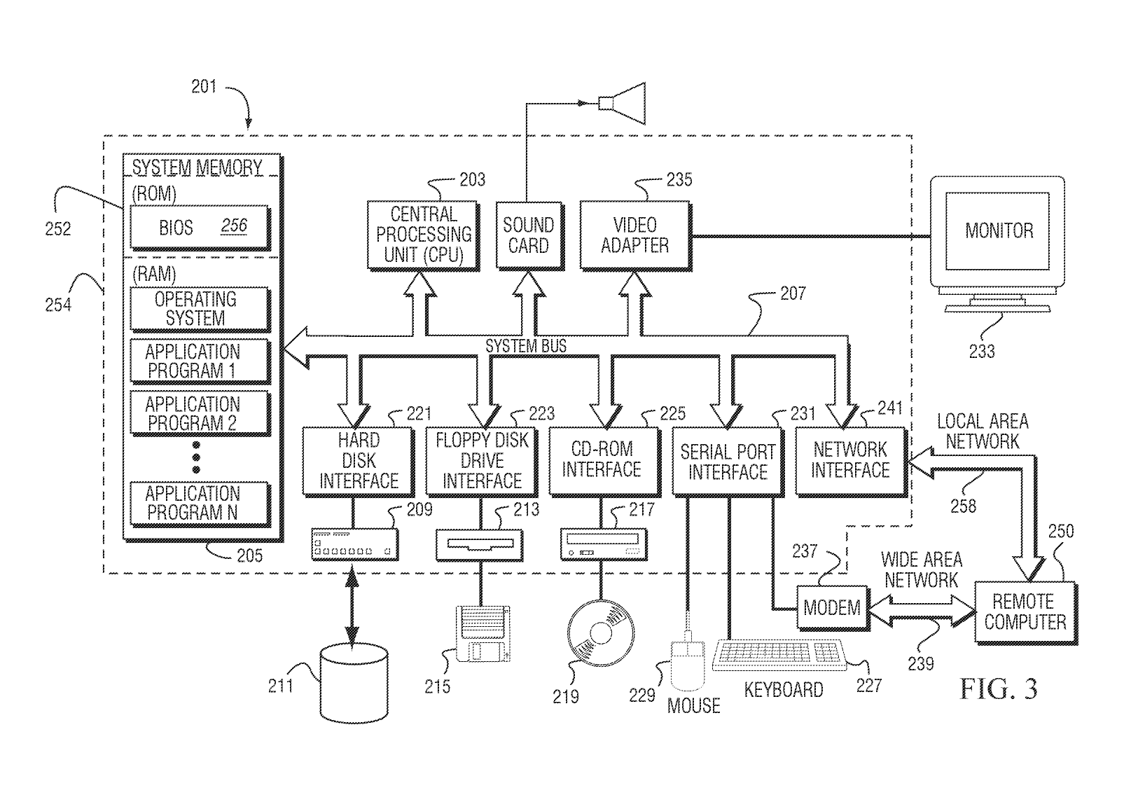

FIG. 3 generally illustrates a computer system 201 suitable for use as the client and server components of the described system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable “floppy” or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite dish, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem or broadband or wireless adapter 237 or other means for establishing communications over the wide area network 239, such as the Internet. The modem 237, which may be internal or external, is connected to the system bus 207 via the serial port interface 231. A network interface 241 may also be provided for allowing the computer system 201 to communicate with a remote computing device 250 via a local area network 258 (or such communication may be via the wide area network 239 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used, and the invention is not limited in this respect.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of administering a payment account with access restrictions using a payment system, the method comprising:
(a) enabling a consumer to establish a payment account, the payment account to be administered by the payment system;
(b) enabling the consumer to request a payment of funds from the payment account to enter into a transaction;
(c) the payment system identifying the transaction and accessing account restrictions based on characteristics of the transaction; and
(d) the payment system effecting the payment according to parameters of the transaction and subject to the account restrictions.

2. A method according to claim 1, wherein step (a) is practiced by enabling the consumer to designate the payment account for a predefined purpose, and wherein the predefined purpose includes predefined account restrictions.

3. A method according to claim 2, wherein the predefined purpose is casino gambling, and wherein step (a) is further practiced by obtaining consumer information according to a regulatory authority.

4. A method according to claim 2, wherein step (a) is practiced by verifying the consumer's identity.

5. A method according to claim 2, wherein the predefined purpose is casino gambling, and wherein the account restrictions comprise a daily limit.

6. A method according to claim 5, further comprising reserving an amount of funds in the payment account corresponding to the daily limit, wherein a balance in the account consists of an amount of unreserved funds in the payment account.

7. A method according to claim 5, wherein the account restrictions further comprise at least one of a weekly limit, a monthly limit, an annual limit, and a lifetime limit.

8. A method according to claim 1, wherein the account restrictions comprise self-imposed spending limits input by the consumer.

9. A method according to claim 1, wherein step (b) comprises enabling the consumer to request credit for the payment.

10. A method according to claim 1, wherein the account restrictions are defined by a regulatory authority based on the characteristics of the transaction.

11. A computer system for administering a payment account with access restrictions using a payment system, the computer system comprising:
a network interface enabling at least one user computer running a computer program to establish a payment account; and
a system server running a server program, the at least one user computer and the system server being interconnected by a computer network, wherein the payment account is administered by the system server, upon access to the system server by a consumer, the system server enabling the consumer to request a payment of funds from the payment account to enter into a transaction, the system server identifying the transaction and accessing account restrictions based on characteristics of the transaction, and the system server effecting the payment according to parameters of the transaction and subject to the account restrictions.

12. A computer system according to claim 11, wherein the at least one user computer executes the computer program to enable the consumer to designate the payment account for a predefined purpose, and wherein the predefined purpose includes predefined account restrictions.

13. A computer program according to claim 12, wherein the predefined purpose is casino gambling, and wherein the account restrictions comprise a daily limit.

14. A computer program according to claim 13, wherein the server system executes the server program to reserve an amount of funds in the payment account corresponding to the daily limit, wherein a balance in the account consists of an amount of unreserved funds in the payment account.

15. A computer program according to claim 11, wherein the account restrictions comprise self-imposed spending limits input by the consumer.

16. A non-transitory computer-readable medium programmed for administering a payment account with access restrictions using a payment system, the non-transitory computer-readable medium comprising:
means for enabling a consumer to establish a payment account, the payment account to be administered by the payment system;
means for enabling the consumer to request a payment of funds from the payment account to enter into a transaction;
means for the payment system identifying the transaction and accessing account restrictions based on characteristics of the transaction; and
means for the payment system effecting the payment according to parameters of the transaction and subject to the account restrictions.
